(19) United States
(12) Patent Application Publication
(10) Pub. No.: US 2009/0217945 A1
(43) Pub. Date: Sep. 3, 2009

(54) Method and Device for Cleaning Slabs, Thin Slabs, Profiled Elements, or Similar

(76) Inventors: Thomas Runkel, Siegen (DE); Bernhard Ehls, Hilchenbach (DE); Otmar Jannasch, Duisburg (DE); Andreas Houben, Mönchengladbach (DE); Jürgen Armenat, Hilchenbach (DE); Jürgen Hemmerle, Düsseldorf (DE); Karl Rittner, Hilden (DE); Uwe Kopfstedt, Meerbusch (DE); Ingo Schuster, Willich (DE); Peter Jonen, Duisburg (DE); Carsten Lippold, Seesen (DE)

Correspondence Address: FRIEDRICH KUEFFNER, 317 MADISON AVENUE, SUITE 910, NEW YORK, NY, 10017, US

(21) Appl. No.: 12/083,040

(22) PCT Filed: Sep. 20, 2006
(86) PCT No.: PCT/EP2006/009108

§ 371 Date: Mar. 24, 2009

(30) Foreign Application Priority Data
Oct. 6, 2005 (DE) 10 2005 047 936.7

(51) Int. Cl. B08B 3/02

(52) U.S. Cl. 134/9; 134/50

(57) ABSTRACT

Disclosed is a method for removing loose scale and other foreign matter from the top and/or bottom face of a cast product (3), such as a slab, thin slab, profiled element, or similar, with the aid of flowable media which are sprayed onto the cast product (3) by means of a cleaning device (5) comprising at least one spraying apparatus (8, 9) that is disposed above the cast product (3) and at least one spraying apparatus (8, 9) that is arranged below the cast product (3). According to said method, the amount of media and/or the effective width and/or the pressure of the media is/are controlled separately and independently of time for each spraying apparatus (8, 9). The invention also relates to a device for removing loose scale and other foreign matter from the top and/or bottom face of a cast product (3) with the aid of flowable media which are sprayed onto the cast product (3) by means of a cleaning device (5) comprising at least one spraying apparatus (8, 9) located above the cast product (3) and at least one spraying apparatus (8, 9) located below the cast product (3). The spraying apparatuses (8, 9) and/or the nozzles (13) that are placed on the spraying apparatuses (8, 9) are configured so as to respond via a controller/a guiding system.

The invention concerns a method for removing loose scale and other foreign substances from the upper surface and/or lower surface of a cast product, such as a slab, thin slab, profiled element, or the like, with the aid of flowable media, which are sprayed onto the cast product by means of a cleaning device that consists of at least one spray arrangement positioned above the cast product and at least one spray arrangement positioned below the cast product. The invention also concerns a corresponding cleaning device.

WO 2002/070157 A1 discloses a method for descaling strip in a rolling mill with a descaler and with a finishing train arranged downstream of the descaler in the running direction of the strip. In this method, water under descaling pressure acts on the upper and lower surfaces of the strip, and the strip is cooled in the finishing train. During descaling, a symmetrical temperature distribution is produced on the upper and lower surfaces of the strip inside the descaler and is maintained in the same way inside the finishing train. The invention pertains to a descaling operation in combination with a rolling mill.

EP 1 083 010 A2 discloses an adjusting method for two shielding elements, in which a metal strip with a strip width, a strip center, and edge regions is conveyed in a direction of conveyance on a roller table with a roller table center. The metal strip has a temperature gradient over its width. The edge regions of the metal strip are shielded from a cooling medium by shielding elements. In this regard, the shielding elements are adjusted in such a way that the temperature gradient downstream of the shielding elements with respect to the direction of strip conveyance approaches a set temperature gradient. To this end, the shielding elements are adjusted asymmetrically with respect to the center of the roller table. This invention describes a method for controlling the spray width, which necessitates the use of shielding elements.

DE 32 30 866 C2 describes a device for a cooling steel sheet panel immediately after hot rolling. The device is constructed with a horizontal rolling table for the steel sheet panel; with a plurality of spray pipes, which extend in the width direction of the steel sheet panel and are arranged above and below the steel sheet panel at predetermined intervals in the longitudinal direction of the steel sheet panel, and each of which has a length that is essentially equal to the width of the steel sheet panel; with several nozzles for spraying cooling water onto the steel sheet panel; and with shielding elements, which are arranged in the region of the two lateral edges of the steel sheet panel for interrupting the jets of cooling water and whose bases are downwardly slanted away from the center of the steel sheet panel. A shifting device is used to move the shielding elements towards each other and away from each other in the width direction of the steel sheet panel lying on the roller table. The shifting device has:
two stationary guide frames, which are arranged essentially horizontally above the roller table in such a way that they intersect the vertical center plane of the roller table;
two support frames, which are arranged essentially horizontally above both sides of the roller table parallel to its center plane and whose two ends are slidably supported in the guide frames, such that the shielding element arranged in the area of one of the lateral edges of the steel sheet panel lying on the roller table is mounted on one of the two support frames, and the other shielding element arranged in the area of the other lateral edge of the steel sheet panel is mounted on the other support frame, and
a drive for moving the two support frames, together with the two shielding elements, towards each other and away from each other by the same distances in the width direction of the steel sheet panel lying on the roller table.

This invention describes a device, in which shielding elements are used, for cooling a steel sheet panel after it has been hot rolled.

EP 0 153 688 B1 discloses a method for cooling hot steel sheet from an upstream hot rolling train. The steel sheet is guided in the longitudinal direction through pairs of upper and lower rolls arranged in the direction of conveyance of the steel sheet, and cooling water is supplied to the upper and lower surfaces of the steel sheet by nozzles on several cooling units arranged in the same longitudinal direction. Each cooling unit is arranged between adjacent pairs of upper and lower rollers. The method consists in determining the temperature distribution in the steel sheet before the start of cooling; setting the desired mean cooling rate; determining the distance from the edge of the sheet along which the supply of cooling water at least to the underside of the steel sheet is to be interrupted on the basis of the temperature distribution, so that the temperature of the inner edge section of the steel sheet is kept above the temperature of the middle section in order to ensure that the Ar₃ transformation in the inner edge section occurs at the same time as or later than the Ar₃ transformation in the middle section; and shielding a suitable number of nozzles to interrupt the direct supply of cooling water to the edge section of the steel sheet over the distance determined by the preceding process step. This invention applies to the hot steel sheets after hot rolling for the purpose of producing specific sheet characteristics by well-defined cooling.

A cleaning device for removing loose scale from the surface of a slab, especially a thin slab produced in a mini mill, is described, for example, by DE 101 43 868 A1 and WO 2003/022475 A1. A mini mill of this type comprises at least a slab casting machine, a slab cutting device, a temperature equalizing furnace, and one or more rolling stands with a coiling installation. A device of this type is improved if a spray arrangement comprises at least one spray pipe each above and below the slab, with each spray pipe having a plurality of spray nozzles. The spray arrangement is positioned upstream of the temperature equalizing furnace, especially a roller hearth furnace. The spray arrangement is connected to a water supply that has the technologically required pressure and a volume flow that is adapted to the number of spray nozzles. Claim 6 states that the water supply pressure to the spray pipes of the spray arrangement is 5-15 bars and preferably less than 10 bars.

The existing solutions describe devices with no means of adjustment. If one assumes a cleaning device with fixed settings of the amount of medium, cleaning width and position, the lack of flexibility results, for example, in undesired cooling of the thin slab and increased production risk. In addition, the upper surface and lower surface experience different amounts of cooling. With the same amount of medium and the same medium pressure, the upper surface of the thin slab is more strongly cooled than the lower surface due to the longer exposure time. The head of the thin slab then tends to rise. This makes the passage of the thin slab through the downstream installations more difficult.

When the head of the thin slab strikes something in the downstream installations, a conveyance interruption can occur. This makes it necessary to shut down the casting installation.

The outer edges of the thin slab are more strongly cooled than the middle region. In addition, this effect is also dependent on the current slab width. The causes are:

The medium applied in the middle of the thin slab flows towards the outer edges; therefore, the amount of medium and the cooling effect are greater at the edges. The cleaning medium reaches the thin slab not only from above but also, depending on the design, from the outside.

There is the danger of cooling the slab edges too strongly.

The cooling of the thin slab depends on the casting speed. At lower casting speeds, the cooling is more intense than at higher casting speeds when the same amount of medium is applied. The casting speed of a casting plant is typically varied according to the production conditions, including the production conditions within a casting sequence. At the end of a casting sequence, the last length of thin slab is ordinarily separated and lies on the roller table. If the cleaning device is used, this last section of thin slab cools so strongly that any possible downstream cutting operations for reducing the size of the last section of thin slab must cut a material that is much colder and thus stronger.

If any interruption occurs in the casting plant that makes it impossible to continue moving the thin slab out of the plant, the thin slab must be cut into lengths to allow it to be removed. In the vicinity of the cleaning device, the presence of the cleaning device makes it difficult for personnel to reach the thin slab. In this regard, quick access to the thin slab is necessary to prevent the hot thin slab, which is no longer being conveyed, from overheating and thus damaging parts of the plant.

When the casting process is started up, the head of the thin slab can strike the cleaning device, especially if the space between the surface of the thin slab and the cleaning device is very tight. An undesired side effect of the cleaning device is the cooling of the thin slab. The cooling is greater the longer the medium has contact with the thin slab.

With increasing medium pressure, the danger of medium escaping from the cleaning device increases. If this occurs, foreign substances, such as scale, may be carried back onto the surface of the thin slab.

The objective of the invention is to improve the previously known cleaning devices in such a way that the properties of the cast product, such as a slab, thin slab, profiled element or the like, are improved by flexible means of adjustment, specifically, of the cooling medium, and to avoid the disadvantages described above.

In accordance with the invention, this objective is achieved by virtue of the fact that in a method of the type specified in the introductory clause of Claim 1, the amount and/or the effective width and/or the pressure of the flowable media is controlled separately and independently with respect to time for each spray arrangement.

Further refinements of the method are described in the dependent method claims.

The invention also concerns a device for carrying out the method of the invention. In this device, the spray arrangements and/or the nozzles located on the spray arrangements are designed to respond to a control/guidance system.

Further refinements of the device are described in the dependent device claims.

The decisive advantage of the method of the invention is that controllable means of adjustment for the amount and/or the effective width and/or the pressure of the flowable media can be used for separate control of the upper and lower medium supply at every point in time.

In this way, loose scale and other foreign substances are removed as early as possible from the upper and/or lower surface of the cast product. With several additional devices, the use of the cleaning device becomes much more flexible and reliable.

With means for adjusting the effective width of the cleaning device to the width of the cast product, excessive cooling of the edges of the cast product is avoided. Depending on the design, the cleaning device can also follow a casting width change of the current cast product. The width adjustment can be made by a switching device and/or by manual devices for shutting down a definite number of medium supply lines.

With means for adjusting the amount of medium and/or the effective width and/or the medium pressure, the amount of medium can be varied according to the casting speed. This makes it possible to control the cooling independently of the casting speed and the cast material.

With means for completely stopping the supply of medium to the cleaning device, the supply of medium can be completely shut off, e.g., at the end of casting.

With means for partly or completely removing the cleaning device from the casting line, access to the cast product is greatly improved. For example, the cleaning device can be laterally removed from the casting line, or the parts installed above the thin slab can be lifted off with a lifting device.

The means of the preceding point are improved if the removal is effected with a remotely controlled drive. These means are also improved if time-consuming disconnection of supply lines is eliminated by flexible medium connections or self-closing medium couplings.

With several measures used individually or together, the residence time of the flowable medium on the surface of the cast product can be shortened. Depending on requirements, the devices can be used upstream and/or downstream of the cleaning device:
An additional spraying off of the cast product with flowable medium that can be adjusted in its amount and/or effective width and/or pressure, for example, low-pressure water, prevents the flow of medium in the casting direction or in the direction opposite the casting direction.
An additional blowing off of the cast product with air helps the medium flow off to the sides.
Collecting channels can be used to remove the medium from the upper surface of the cast product.

The cleaning device is enclosed in a housing—if this is possible from a design standpoint. The streams of medium are possibly collected with collecting channels and drained away to the sides in a well-defined way. To assist the draining off of the medium, flushing with medium can be provided in these collecting channels.

All of the means of adjustment described above can be activated differently. In this regard, depending on the adjustment parameter, the activation can be accomplished from one or more places that are possibly blocked relative to each other:
Manually from the appropriate control platforms of the casting installation.
Manually from an on-site control console.
Automatically from a guidance system used expressly for the cleaning of the cast product.
When there is connection with a higher-order guidance system, adjustments that depend on the production process can be partly or completely automated or can be provided in advance to the operating personnel as proposed values.

The invention allows more flexible use and more reliable production operation of a cleaning device and a better cleaning effect and reduction of undesired side effects. In addition, the adjustments of the cleaning device can be adapted with automation to the different casting parameters and casting production steps.

A specific embodiment of the invention is described in greater detail below with reference to the highly schematic drawings.

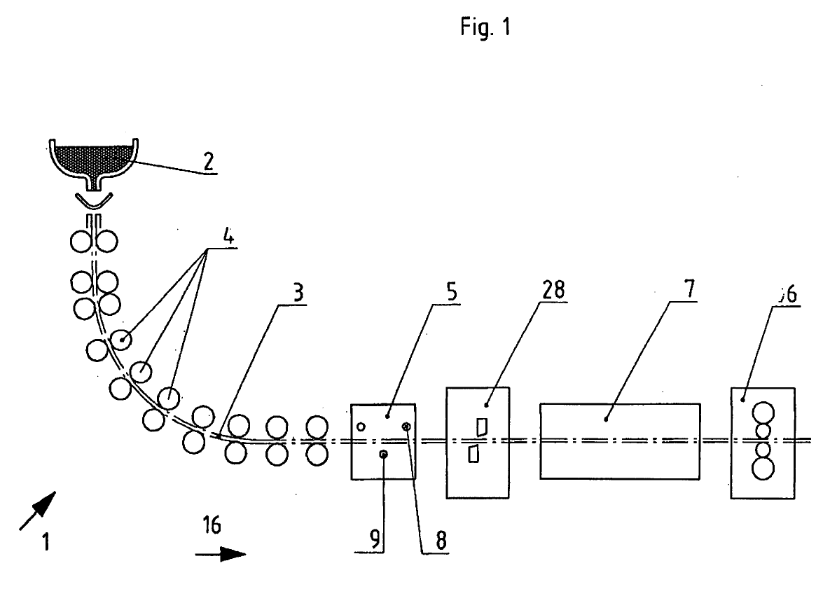

FIG. 1 shows a schematic side view of a thin slab installation.

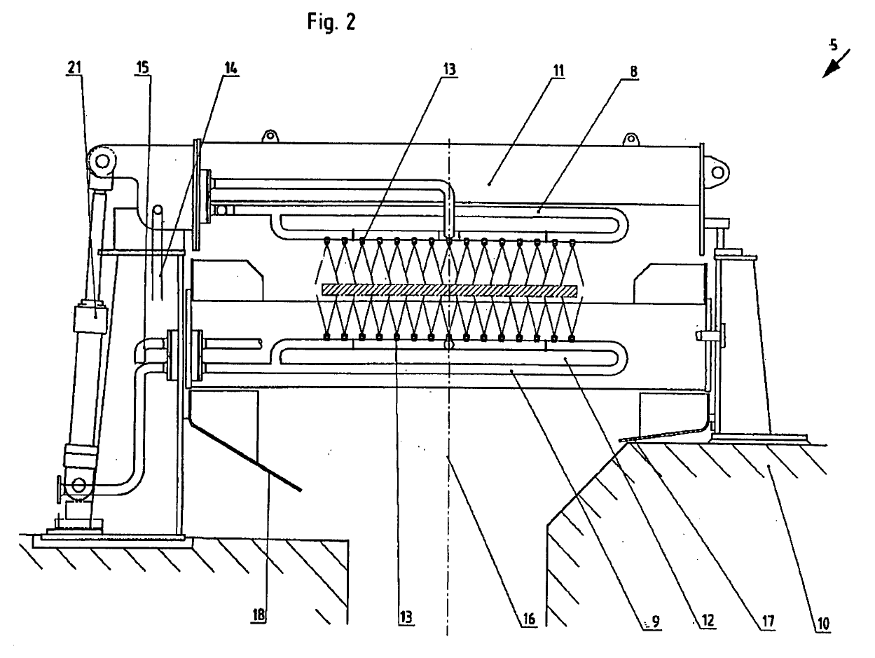

FIG. 2 shows a side view of a cleaning device of the invention within the casting line.

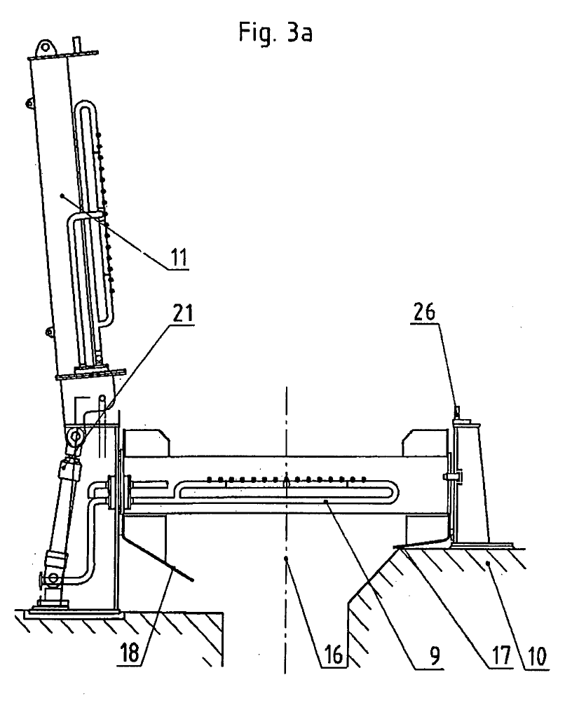

FIG. 3a shows a side view of the cleaning device of the invention, opened by swinging it up.

FIG. 3b shows a side view of the cleaning device of the invention outside the casting line (laterally displaceable design)—

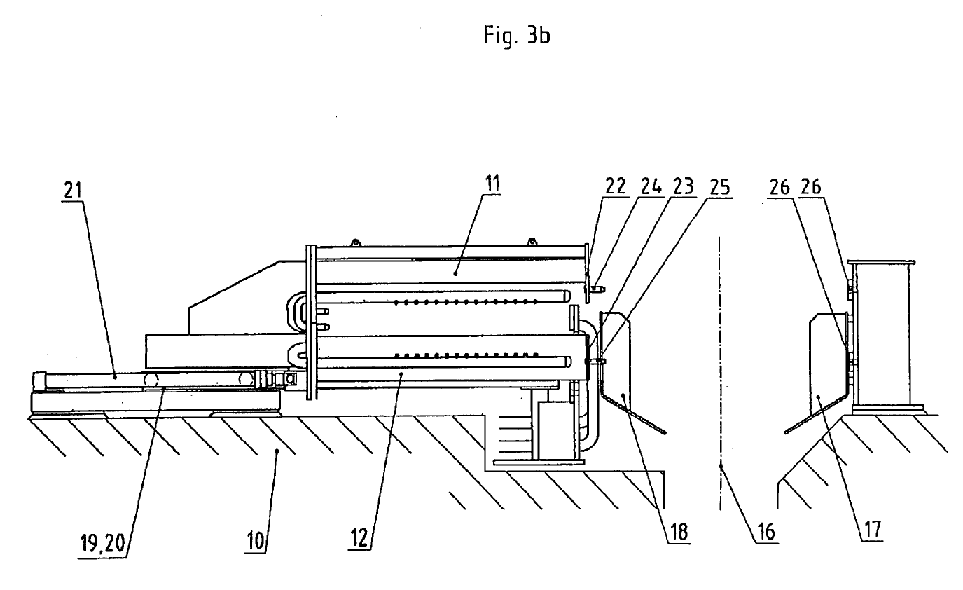

FIG. 4 shows a possible arrangement of the spray arrangements in detail.

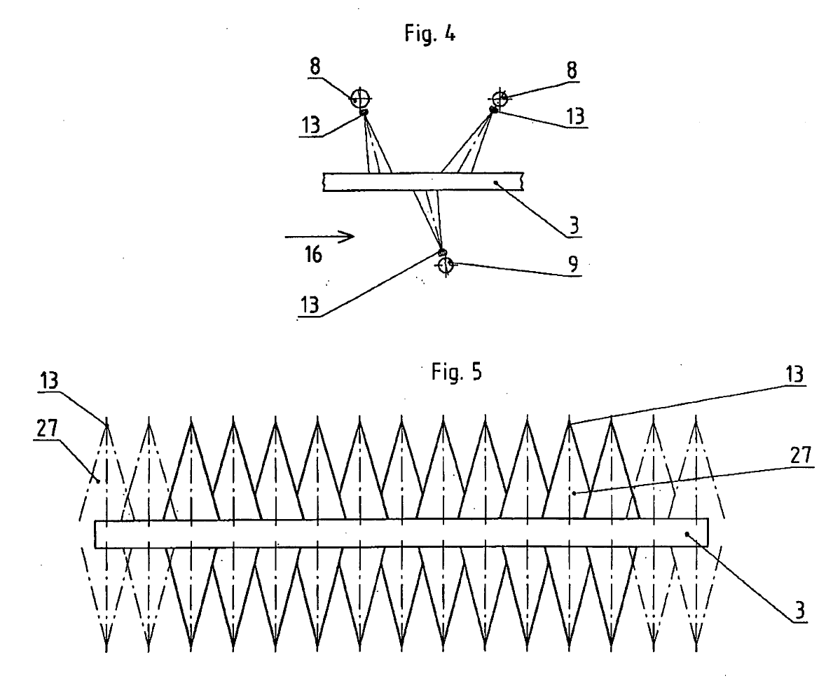

FIG. 5 shows an arrangement of spray nozzles in detail (nozzles that can be turned off are drawn with a different type of line).

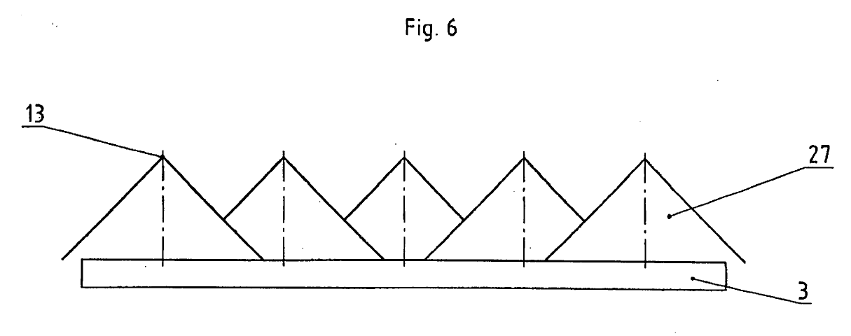

FIG. 6 shows a system for longitudinal spraying in detail.

FIG. 1 shows a casting plant. The cast product 3 emerging from a casting installation 2 is turned by rollers 4 from a vertical to a horizontal position. The cast product 3 then passes through a cleaning device 5. In the cleaning device 5, scale and other foreign substances are removed from the upper and/or lower surface of the cast product 3. To allow further processing, for example, in a rolling mill 6, the cast product 3 is heated in a heating installation 7. The cleaning device 5 is provided with at least one spray arrangement 8 positioned above the cast product 3 and at least one spray arrangement 9 positioned below the cast product 3. A cutting device 28 (e.g., a shear) is installed upstream or downstream of the cleaning device 5.

An example of a cleaning device 5 is shown in greater detail in FIG. 2. The cleaning device 5 installed/mounted on a foundation 10 consists of a top frame 11 and a bottom frame 12. Spray arrangements 8, 9 are mounted on the top frame 11 and the bottom frame 12. The spray arrangements 8, 9 are furnished with a plurality of nozzles 13. The spray arrangements 8, 9 are supplied with a flowable medium via lines 14, 15. Deflectors 17, 18 are mounted below the casting line 16 to help carry away the flowable medium.

The top frame 11 is supported in such a way that it can swivel up and down. As shown in FIG. 3a, it can be swung out of the casting line 16 by means of a hydraulic cylinder 21.

Alternatively, the cleaning device 5 is displaceably mounted on rails 19, 20 and can be moved out of the casting line 16 by means of a hydraulic cylinder 21. FIG. 3b shows this alternative cleaning device 5 outside the casting line 16. In the embodiment illustrated here, the top frame 11 and the bottom frame 12 are designed with a U shape. To stabilize the cleaning device 5, the free ends 22, 23 are set by means of pins 24, 25 in corresponding bores of an abutment 28.

FIG. 4 shows details of a system with two spray arrangements 8 positioned above the cast product 3 and one spray arrangement 9 positioned below the cast product 3. The nozzles 13 are oriented in such a way that they spray the cast product 3 with the flowable medium in the casting direction 16 or opposite the casting direction 16. To this end, the nozzles 13 can be oriented, for example, at a fixed angle.

The two spray arrangements 8 positioned above the cast product are oriented in opposite directions. This reduces the emergence of the flowable medium in the casting direction and in the direction opposite the casting direction.

FIG. 5 shows details of an arrangement of nozzles 13. The spray cones 29 are configured in such a way that they overlap. Therefore, the flowable medium strikes the entire surface of the cast product 3. Design measures can be taken to allow a well-defined number of outwardly arranged nozzles to be turned off.

FIG. 6 shows a number of nozzles 13, which are arranged for an alternative system of longitudinal spraying.

### LIST OF REFERENCE NUMBERS

1. casting plant
2. casting installation
3. cast product
4. rollers
5. cleaning device
6. rolling mill
7. heating installation
8. spray arrangement
9. spray arrangement
10. foundation
11. top frame
12. bottom frame
13. nozzles
14. line
15. line
16. casting line
17. deflector
18. deflector
19. rail
20. rail
21. hydraulic cylinder
22. free end
23. free end
24. pin
25. pin
26. abutment
27. spray cone
28. cutting device

1. A method for removing loose scale and other foreign substances from the upper surface and/or lower surface of a cast product (3), such as a slab, thin slab, profiled element, or the like, with the aid of flowable media, which are sprayed onto the cast product (3) by means of a cleaning device (5) that consists of at least one spray arrangement (8) positioned above the cast product (3) and at least one spray arrangement (9) positioned below the cast product (3), where a heating installation (7) and a rolling mill (6) are installed downstream of the cleaning device (5), wherein the amount of medium and/or the effective width and/or the pressure of the medium is controlled separately and independently with respect to time for each spray arrangement (8, 9).

2. A method in accordance with claim 1, wherein the cleaning device (5) is operated with at least one static spray arrangement (8, 9).

3. A method in accordance with claim 1, wherein the cleaning device (5) is operated with at least one movable spray arrangement (8, 9).

4. A method in accordance with claim 1, wherein the cleaning device (5) is operated in the low-pressure range.

5. A method in accordance with claim 1, wherein the cleaning device (5) is operated in the high-pressure range.

6. A method in accordance with claim 1, wherein the means of adjusting the spray arrangements (8, 9) are operated independently of the casting speed and/or the cast material.

7. A method in accordance with claim 1, wherein the supply of medium can be completely stopped.

8. A method in accordance with claim 1, wherein the cleaning device (5) is enclosed in a housing.

9. A method in accordance with claim 1, wherein the cleaning device (5) can be moved laterally completely out of the casting line (16).

10. A method in accordance with claim 1, wherein the part of the cleaning device (5) located above the cast product (3) is removed.

11. A method in accordance with claim 9, wherein the cleaning device (5) is moved out or lifted out with a remotely controlled drive.

12. A method in accordance with claim 1, wherein the cleaning device (5) is connected to supply lines (14, 15) by medium connections that are flexible.

13. A method in accordance with claim 1, wherein the cleaning device (5) is connected to supply lines (14, 15) by self-closing medium couplings.

14. A method in accordance with claim 1, wherein an additional spraying off of the cast product (3) with medium that can be adjusted in its amount and/or pressure prevents the flow of medium in the casting direction (16) or in the direction opposite the casting direction (16).

15. A method in accordance with claim 1, wherein at least an additional blowing off of the cast product with air helps the medium flow off to the sides.

16. A method in accordance with claim 1, wherein collecting channels are used to remove the medium from the upper surface of the cast product.

17. A method in accordance with claim 14, wherein the additional devices (device for spraying off the cast product with medium, device for blowing off the cast product with air, medium collecting device) are used upstream and/or downstream of the cleaning device (5).

18. A method in accordance with claim 1, wherein the control system of the cleaning device (5) is operated by connection with a higher-order guidance system.

19. A method in accordance with claim 1, wherein the adjustments of the cleaning device (5) that depend on the production process are partly or completely automated.

20. A method in accordance with claim 1, wherein the adjustments of the cleaning device (5) that depend on the production process are provided in advance to the operating personnel as proposed values.

21. A device for removing loose scale and other foreign substances from the upper surface and/or lower surface of a cast product (3) with the aid of flowable media, which are sprayed onto the cast product (3) by means of a cleaning device (5) that consists of at least one spray arrangement (8) positioned above the cast product (3) and at least one spray arrangement (9) positioned below the cast product (3), where a heating installation (7) and a rolling mill (6) are installed downstream of the cleaning device (5), especially for carrying out a method in accordance with claim 1, wherein the spray arrangements (8, 9) and/or the nozzles (13) located on the spray arrangements (8, 9) are designed to respond to a control/guidance system.

22. A device in accordance with claim 21, wherein the cleaning device (5) is enclosed in a housing.

23. A device in accordance with claim 21, wherein the cleaning device (5) has a two-part design.

24. A device in accordance with claim 21, wherein the cleaning device (5) has a one-part design.

25. Device in accordance with claim 21, wherein the lines (14, 15) are designed with flexible medium connections and/or self-closing medium couplings.
